(19) United States
(12) Patent Application Publication
(10) Pub. No.: US 2014/0372941 A1
(43) Pub. Date: Dec. 18, 2014

(54) DISCRETE SECOND WINDOW FOR ADDITIONAL INFORMATION FOR USERS ACCESSING AN AUDIO OR MULTIMEDIA CONFERENCE

(71) Applicant: Avaya Inc., Basking Ridge, NJ (US)

(72) Inventors: Shane PARSONS, Napanee (CA); Scott SEWELL, Belleville (CA)

(21) Appl. No.: 13/919,317

(22) Filed: Jun. 17, 2013

(51) Int. Cl. G06F 3/0482

(52) U.S. Cl. CPC G06F 3/0482
USPC 715/803; 715/810; 715/781

(57) ABSTRACT

A method and system are provided in which at least one predefined criterion is stored. Participant data is received and includes a list of participants in the conference and a subset of participant data associated with each participant in the list. A determination is made as to whether at least one participant in the list of participants in the conference is associated with the subset of participant data meeting the predefined criterion. The list of participants in the graphical user interface is displayed. The at least one participant associated with the subset of participant data that meets the predefined criterion is displayed in the graphical user interface at a place other than the place where the list of participants in the conference is displayed in the graphical user interface. The at least one participant is displayed at the same time as the display of the subset of participant data.

### FIELD OF THE INVENTION

The present invention relates to audio or multimedia conferencing, and in particular to a method and system for providing configurable real-time information associated with one or more participants in the conference.

### BACKGROUND OF THE INVENTION

Audio, video and/or web based conferencing systems are an ever growing way for people to communicate and share ideas. These existing systems allow parties at multiple locations to communicate with each other from different devices such as smartphones, PC softphones and etc. Existing systems provide a client with limited information via a single window in a user interface. For example, the single window of the user interface is designed to only display a roster of participants in a conference, thereby allowing the user to see who is logged into the conference. However, if there are a large number of participants in the conference, the single window of the user interface will not be able to display all the participants due to limited display space. A user is left having to search or scroll through the participant list to find if one or more parties have joined the conference.

Some of these existing systems provide additional information in the single window of the user interface such as which one of the participants is the active speaker in the conference. Typically, the active speaker in the conference is indicated by a dot or other symbol next to the name of the participant in the interface. In other words, no other information is typically provided by user interface to the user besides a list of participants and an indication of a single active speaker next to one of the participant's name. If the participant roster is large, a user may have to inconveniently scroll through the list to find the active speaker.

### SUMMARY OF THE INVENTION

The prevent invention advantageously provides a method and system for providing real-time information in a conference.

In accordance with one aspect of the invention, a computing device for providing a graphical user interface for a conference is provided. The computing device includes a memory configured to store at least one predefined criterion. The computing device further includes a receiver configured to receive participant data. The participant data includes a list of participants in the conference and a subset of participant data associated with each participant in the list of participants in the conference. The computing device further includes a processor configured to determine if at least one participant in the list of participants in the conference is associated with the subset of participant data that meets the at least one predefined criterion. The computing device further includes a display configured to display the list of participants in the graphical user interface and display, in the graphical user interface at a place other than the place where the list of participants is displayed in the graphical user interface, the at least one participant associated with the subset of participant data that meets the at least one predefined criterion. The at least one participant is displayed at the same time as the display of the first subset of participant data.

In accordance with another aspect of the invention, a system for updating participant data displayed in a graphical user interface at a user device is provided. The participant data is associated with at least one participant in a conference. The system includes a server. The server includes a memory configured to store participant data. The participant data includes at least a list of participants in a conference and a subset of participant data associated with at least one participant in the list. The server includes a processor configured to cause transmission of the list of participants in the conference and the subset of participant data for display in respective windows in the graphical user interface.

In accordance with another aspect to of the invention, a method for providing a graphical user interface at a computing device for a conference. At least one predefined criterion is stored. Participant data is received in which the participant data includes a list of participants in the conference and a subset of participant data associated with each participant in the list. A determination is made if at least one participant in the list of participants in the conference is associated with the subset of participant data that meets the at least one predefined criterion. The list of participants in the graphical user interface is displayed. The at least one participant associated with the subset of participant data that meets the at least one predefined criterion is displayed in the graphical user interface at a place other than the place where the list of participants in the conference is displayed in the graphical user interface. The at least one participant associated with the subset of participant data that meets the at least one predefined criterion being displayed at the same time as the display of the subset of participant data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary conferencing system constructed in accordance with the principles of the present invention.

FIG. 2 is another illustration of an exemplary graphical user interface in accordance with the principles of the present invention.

FIG. 3 is a flowchart of an exemplary updating information displayed at the graphical user interface in accordance with the principles of the present invention;

FIG. 4 is a flowchart of an exemplary process for updating participant data in accordance with the principles of the present invention;

FIG. 5 is a flowchart of an exemplary response process in accordance with the principles of the present invention; and

FIG. 6 is a flowchart of exemplary conferencing system processes in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to providing configurable real-time information about one or more participants in a conference. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for providing displayable information about one or more conference participants to user interfaces in an audio or multimedia conference.

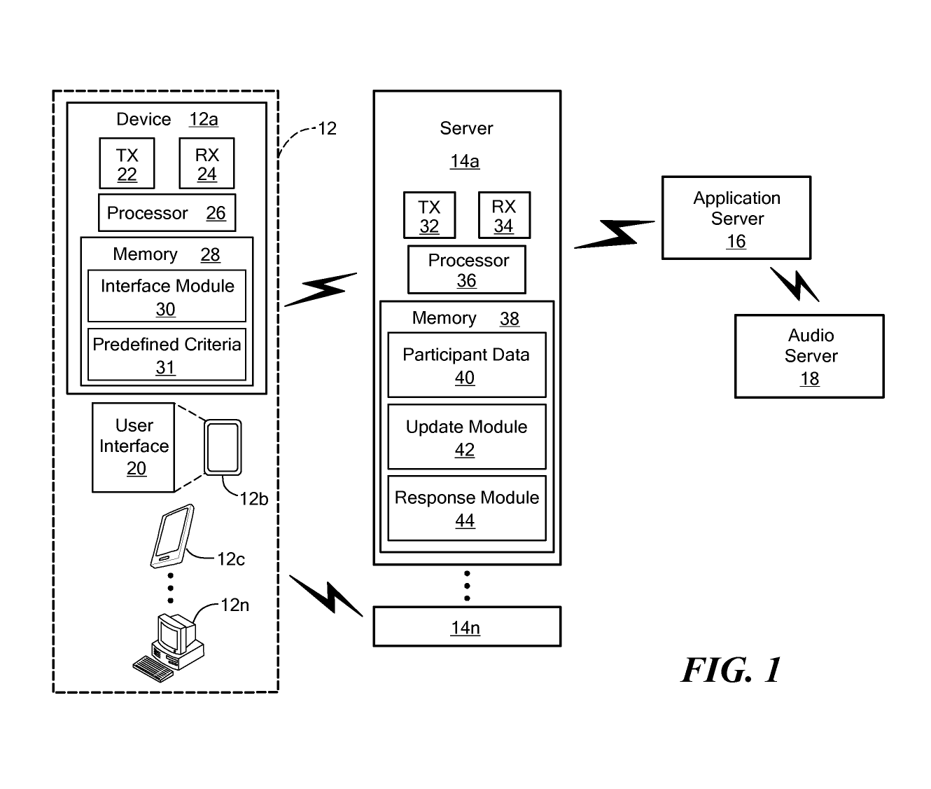

Referring now to the drawing figures, in which like reference designators denote like elements, there is shown in FIG. 1 an exemplary conferencing system constructed in accordance with the principles of the present invention and designated generally as “10.” System 10 includes one or more devices 12a-12n (collectively referred to as “device 12”), one or more servers 14a-14n (collectively referred to as “server 14”), one or more application servers 16a-16n (collectively referred to as “application server 16”) and one or more audio servers 18a-18n (collectively referred to as “audio server 18”) in communication with each other via one or more networks such as intranet and/or internet.

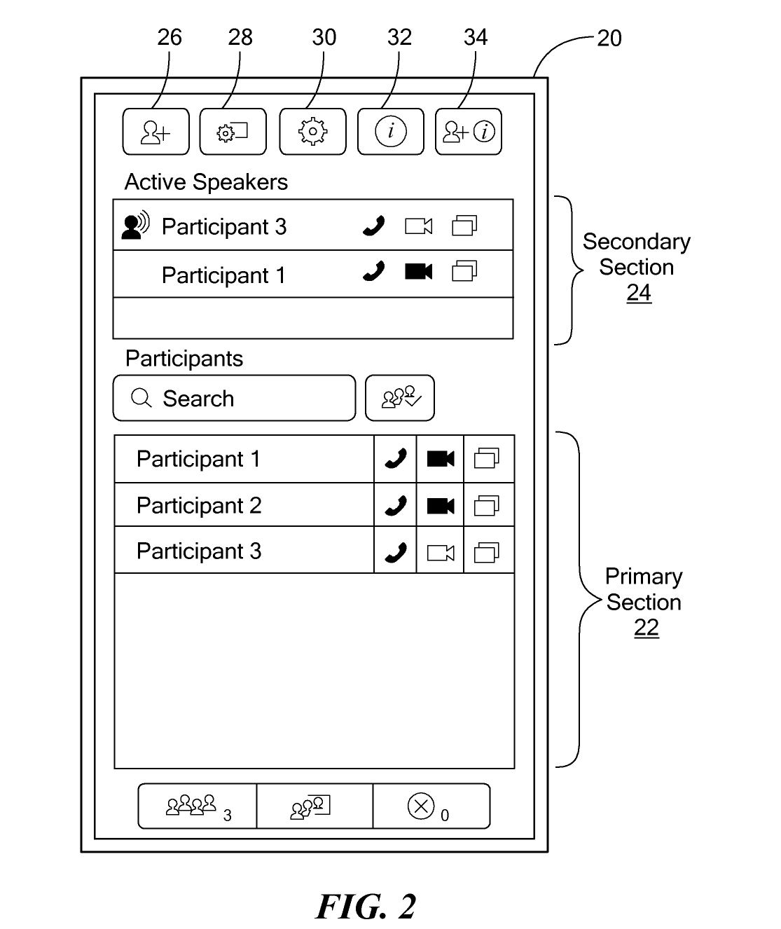

Device 12 is configured to display user interface 20, i.e., graphical user interface 20, such that user interface 20 provides various information to user of device 12. For example, user interface 20 may display a participant list and one or more other subsets of data that can be configured by the user, as is described in detail with respect to FIG. 2. The participant may list one or more participants in which a participant is any individual involved in the conference regardless of role. Device 12 includes one or more transmitters 22 and one or more receivers 22 for communicating with personal agent sever 14. Device 12 further includes one or more central processing units (CPUs) or processors 26 for performing user device functions described herein. Device 12 may download Flash code providing user interface 20 and user interface functionality, as described herein.

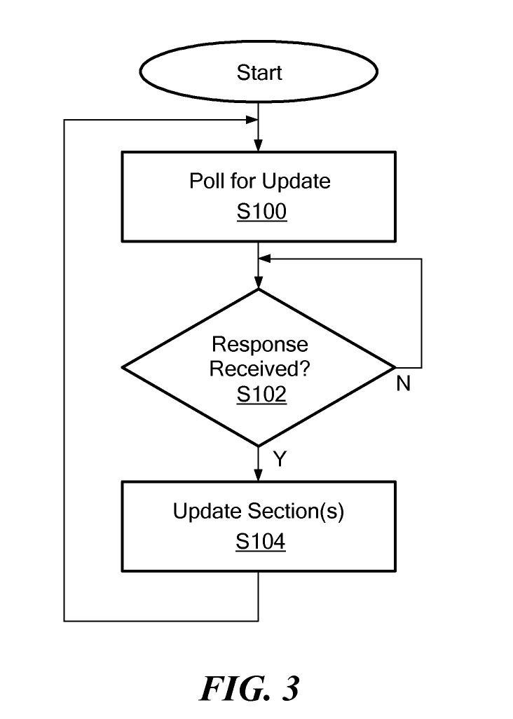

Device 12 further includes memory 28 in which memory 28 may include non-volatile and volatile memory, e.g., non-transitory computer readable medium storing program instructions that may be executed by processor 26 such as to cause processor 26 to perform the functions described herein. Non-volatile memory may include a hard drive, flash memory, memory stick and the like. Also, volatile memory may include random access memory and other memory known in the art. Memory 28 stores interface module 30, among other modules and data. For example, interface module 30 includes instructions, which when executed by processor 26, causes processor 26 to perform the information updating process, discussed in detail with respect to FIG. 3. Memory 28 stores predetermined criteria 31 in which at least one predetermined criterion 31 must be meet in order to display a participant in section 22 and/or section 24. Memory also stores participant data received from server 14, as discussed in detail with respect to FIG. 3. In an alternative embodiment, predefined criteria 31 may be stored at server 14 such that server 14 performs the determination of whether participant data 40 meets one or more predefined criteria 31, i.e., server 14 “tells” user device 12 what to display in primary section 22 and/or secondary section 24.

Device 12 may be a smartphone 12a, personal computer 12b, tablet 12c, laptop computer, voice over internet protocol (VoIP) phones or a dedicated conference device, among other devices that run software and display user interface 20. User interface 20 may be a smartphone client, personal computer softphone client, tablet client and/or web based client such as a AVAYA Aura Conference collaboration agent that provides the ability for a participant to join the conference and view the conference roster of participants. In particular, the collaboration agent may be a Flash based web collaboration session that can be accessed from any web browser. When a participant enters an access code, the participant is presented with user interface 20.

Server 14 includes one or more transmitters 32 and one or more receivers 34 for communicating at least with device 12 and application server 16 via one or more networks. Server 14 includes processor 36 and memory 38 that generally correspond to the components of device 12, with size and performance being adjusted based on design need, while providing the functionality describe herein with respect to server 14. Memory 38 stores participant data 40 associated with one or more participants in the conference in which participant data 40 includes one or more subsets of participant data 40. Each subset of participant data 40 may correspond to specific information associated with one or more participants in the conference such as whether a participant is an active speaker or participant seniority level. Participant data 40 may be updated based at least in part on received notification message and/or other messages containing updated participant data 40.

The one or more subsets of participant data 40 may include flags in which each flag corresponds to a characteristic of a corresponding participant. For example, participant data 40 may include an active speaker flag that indicates a corresponding participant is an active speaker in the conference if the flag is set to “true” but indicates the participant is not an active speaker if the flag is set to “false.” The one or more flags in participant data 40 may be modified or updated based at least in part on received notification message, and may remain unchanged or substantially unchanged until another notification message is received. For example, an active speaker flag associated with a participant on participant list will be set to “true” based on a received notification message indicating the participant is an active speaker in which the active speaker flag will remain “true” until another notification message is received indicating otherwise.

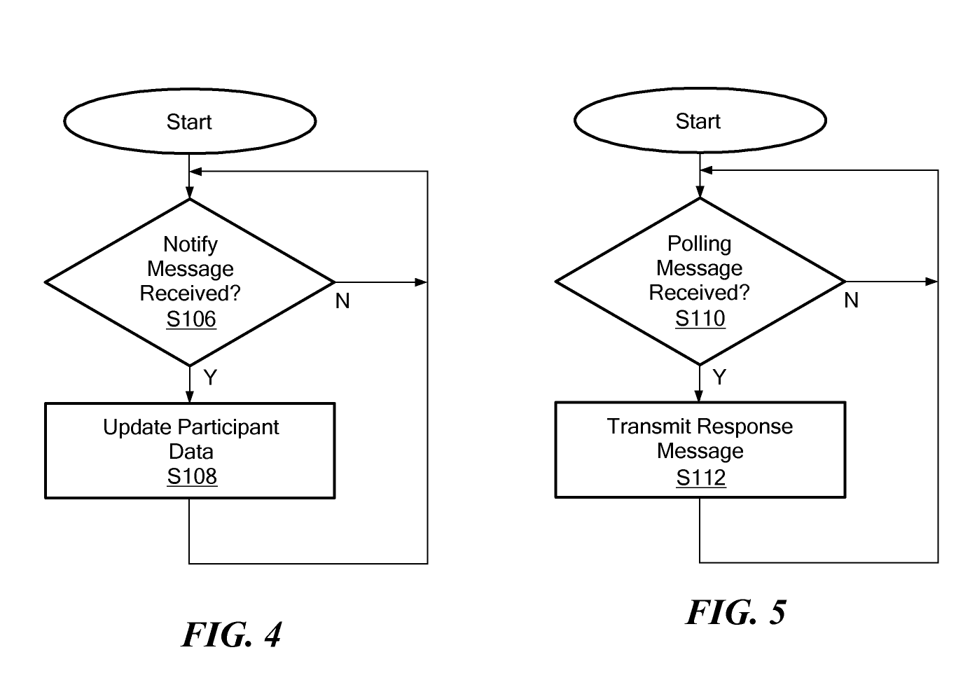

Memory 38 stores instructions such as those for update module 42 and response module 44, among other modules. Update module 42 is configured to update participant data. For example, update module 42 includes instructions, which when executed by processor 36, causes processor 36 to perform the participant data update process, discussed in detail with respect to FIG. 4. Response module 44 performs the response process if a polling message is received. For example, response module 44 includes instructions, which when executed by processor 26, causes processor 26 to perform the response process, discussed in detail with respect to FIG. 5.

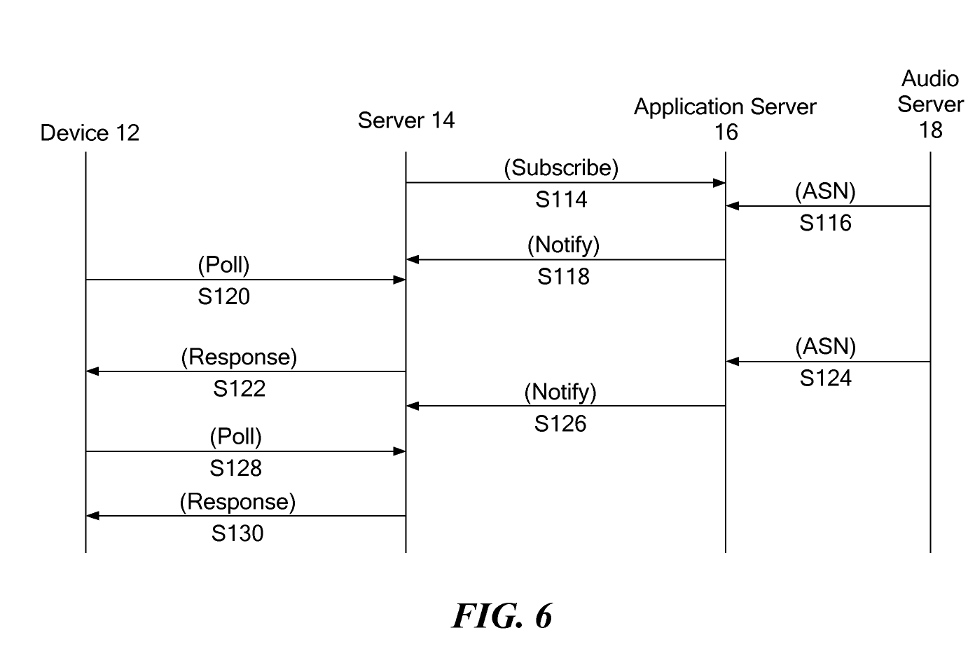

Application server 16 is multimedia conference server (MMCS) that is configured to communicate at least with server 14 and audio server 18 via one or more networks, such as an intranet, the Internet, etc. One example of the MMCS is an AVAYA Aura Conference (AAC) application server. Audio server 18 functions to receive the media path from all devices, mix media paths into a conference, detect one or more “active speaker” and send updates to person application server 16. Mixing and active speaker detection are well known in the art and are beyond the scope of the present invention. Application server 16 receives updates from audio server 18 and transmits corresponding notification message or updates to server 14 as described in detail with respect to FIG. 6. While server 14, application server 16 and audio server 18 are illustrated as being separate devices, the functionality of one or more of these severs may be performed by a single server or device, or fewer than the three separate devices depicted in FIG. 1.

An exemplary user interface 20 is illustrated in FIG. 2. User interface 20 includes one or more sections for displaying information associated with one or more participants based at least in part on participant data 40 received from server 14. Primary section 22 may be preconfigured to display a subset of participant data 40 while secondary section 24 is configurable by user of user device 12 to display one or more of a plurality of subsets of participant data 40. In one embodiment, primary section 22 displays a first subset of participant data corresponding to a list of participants in the conference and secondary section 24 displays participants associated with a second subset of participant data 40 that meet one or more user predefined criteria that was selected from among the predefined criteria 31, i.e., current and previous active speakers. As illustrated in the example of FIG. 2, primary section 22 displays a list of participants, i.e., Participant 1 to Participant 3, and secondary section displays Participant 3 that is the current actives speaker in the conference while Participant 1 is a recent or previous current active speaker in the conference. Primary section 22 and secondary section 24 may be dynamically updated based at least in part on received participant data 40 as described in detail with respect to FIG. 3. In another embodiment, both primary section 22 and secondary section 24 are reconfigurable by user of device 12 to display participants associated with second subset of participant data 40 that meets user selected predefined criterion 31. In other words, a subset of participant data 40 may indicate a specific characteristic associated with each participant such as whether the participant is an active speaker or previous current active speaker. The characteristic used to determine the subset of participant data 40 may also be selected by a moderator or pre-configured by the provider of the system.

One subset of participant data 40 may indicate most active speakers in the conference such as a length of time participants have spoken during the conference, i.e., accumulated current active speaker time. Another subset of participant data 40 may include seniority level of participants in the conference as may be determined by a corporate directory, among other methods. Other subsets of participant data 40 may include key members of the conference such as a conference organizer, when participants joined the conference, when participants left the conference, bandwidth information about the conference, participants who were dropped from the conference due to bandwidth problems, participants who have had their maximum video quality lowered due to bandwidth limitations/priority, participants who have lost video due to bandwidth limitations/priority, participants who are using secure multimedia, participants who are not using secure multimedia, participants who can be promoted to web collaboration presenter, participants who have requested permission to speak/ask a question in the conference, guest participants and participants joining view web page only such as by using One Touch Video for multimedia, among other subsets of participant data 40 that may be displayed in one or more of sections 22 and 24.

User interface 20 further includes a dial out button 26, moderator button 28, settings button 30, information button 32 and participant information button 34, among other buttons. Dial out button 26 allows one or more participants to be added to the conference. Moderator button 28 allows a moderating participant to put the conference into lecture mode, lock the conference and enable the conference to continue even if the moderator is dropped from the conference, among allowing the moderator to perform other functions. Settings button 30 allows a user of device 12 to modify the settings of user interface 20. Participant information button 34 allows a user of device 20 to modify the information displayed in user interface 20, i.e., participant information button 34 allows the user to select one or more criteria for displaying participants in section 22 and/or 24 based at least in part on participant data 40.

An exemplary data updating process for updating information displayed in sections 22 and 24 of user interface 20 is described with reference to FIG. 3. Processor 26 polls server 14 for an update (S100). For example, processor 26 causes transmitter 22 to transmit a poll message that request an update of participant data 40 from server 14. After the poll message has been transmitted, processor 26 determines whether a response message has been received from server 14 (S102). If processor 26 determines a response message has not been received, processor 26 performs the determination of S102 again. Alternatively, processor 26 can restart or end the data updating process if a response message is not received from server 14 within a predetermined amount of time after transmitting the poll message. If processor 26 determines a response message has been received, processor 26 causes section 22 and/or section 24 to be updated based at least in part on the received response message from server 14. For example, the response message may include updated participant data 40 that indicate one or more new current active speakers and/or new participants that meet respective criterion of section 22 and/or section 24, among other updated participant data 40 as described herein. In other words, processor 26 applies predefined criterion 31 to the received participant data 40 in the response message to determine if at least one participant is associated with received participant data 40 that meets the predefined criterion 31. Further, processor 26 may update the list of participants, e.g., add/remove participants, based on the received participant data 40.

An exemplary process for updating participant data 40 stored at server 14 is described with reference to FIG. 4. Processor 36 determines whether a notification message, i.e., NOTIFY message, has been received from application server 16 (S106). If processor 36 determines a notification message has not been received, processor 36 repeats the determination of S106. If processor 36 determines a notification message has been received, processor 36 causes participant data 40 to be updated based at least in part on data included in the notification message, i.e., one or more subsets of participant data 40 is updated based at least in part on information in the notification message (Block S108). For example, the data in notification message may indicate that one or more participants in the conference are current or recent active speakers in which participant data 40 is updated accordingly, i.e., flags associated with these individual participants are modified. After participant data has been updated processor 36 returns to Block S106.

FIG. 5 illustrates an exemplary process for responding to polling message. Processor 36 determines whether a polling message has been received (S110). For example, a polling message may be received from device 12 in which polling message indicates device 12 is requesting participant data 40, i.e., updates or updated participant data 40. If processor 36 determines a polling message has not been received, processor 36 repeats the determination of S110. If processor 36 determines a polling message has been received, processor 36 causes transmitter 32 to transmits participant data 40 in a response message to device 12 that sent the polling message (S112). For example, in response to device 12a sending a polling message, device 12a receives participant data 40 such as an updated list of participants in the conference and corresponding flags that indicate new active speaker(s) in the conference and/or new participant(s) to the conference, among other information associated with one or more participants in the participant list. After the transmission of the response message to device 12, processor 26 repeats the determination of S110.

An exemplary flowchart of several processes performed by system 10 is described with reference to FIG. 6. Server 14 subscribes to application server 16 to receive notification (NOTIFY) messages by sending audio server 18 a subscribe message with an Event parameter “active-talker” (S114). An example notification message is as follows:

NOTIFY sip:2007@ca.avaya.com:30052;maddr=47.11.50.54;transport=tcp
SIP/2.0
From: “9726856300” <sip:9726856300@47.11.50.54>;tag=1339083030149
To: “2007” <sip:2007@ca.avaya.com>;tag=1312116143
CSeq: 3 NOTIFY
Call-ID: 692d342d_137c7917e75@nwilson-6
Via: SIP/2.0/TCP 47.11.50.54:5060;branch=z9hG4bK-29009b-a02a6060-
1dd119de-12C6EE80
Content-Length: 559
Content-Type: application/conference-info+xml
Contact: <sip:9726856300@47.11.50.54:5060>
User-Agent: Avaya Aura Conferencing 15.0.11.0
Max-Forwards: 20
Supported: com.nortelnetworks.firewall
Supported: p-3rdpartycontrol
Supported: nosec
Supported: join
Supported: x-nortel-sipvc
Supported: com.nortelnetworks.im.encryption
Subscription-Expires: 40
Event: conference
Subscription-State: active;expires=40
<?xml version=“1.0” encoding=“UTF-8” standalone=“yes”><conference-info
version=“3” state=“partial”
entity=“sip:9726856300@47.11.50.54:5060;transport=tcp;token=14e14f88_137c
7912f6f” xmlns:ns2=“http://xml.avaya.com/mmcs/1.0/mmcs.xsd”
xmlns=“urn:ietf:params:xml:ns:conference-info”><users state=“partial”><user
state=“partial” entity=“sip:2007@ca.avaya.com;rgslid=a7953c10-b0b5-11e1-
bc80-001cc4912f8e”><endpoint state=“partial”
entity=“2007@ca.avaya.com;gsid=a7953c10-b0b5-11e1-bc80-001cc4912f8e”
ns2:condition=“active-talker”/></user></users></conference-info>

The notification message includes an XML payload which includes participant data 40. The notification message indicates the active speaker via the “ns2:condition=”active-talker” indication.

An example of the subscribe message is as follows:

SUBSCRIBEsip:5990000@ca.avaya.com;maddr=47.11.149.93;token=1c853537_{—}
132167b8518 SIP/2.0
From: “7002” <sip:7002@ca.avaya.com>;tag=166464929
To: “5990000” <sip:5990000@47.11.149.93:5060>
CSeq: 19380 SUBSCRIBE
Call-ID: 11646899_132167c2c73@avaya-1540db3a8
Via: SIP/2.0/UDP 47.11.149.93:30052;branch=z9hG4bK-f20db-3b1857cb-
278309c
Content-Length: 0
Contact: <sip:7002@ca.avaya.com:30052;maddr=47.11.149.93;transport=udp>
User-Agent: Nortel WCM 15.0.0.02011-08-23-0048
Accept: application/conference-info+xml
Expires: 60
Max-Forwards: 20
Supported: x-nt-eow
Allow: REFER
Allow: UPDATE
Event: conference;active-talker

Application server 16 retrieves the event header of the subscribe message and checks if the “active-talker” parameter is present. If the “active-talker” parameter is present, applications server 16 will set the active speaker notification flag in the IMWatchers entry in which the flag is used to find server 14 subscribers from the watchers list. Audio server 18 transmits an ASN message to application server 16 in response to detecting a new active speaker (S116). In this example, a first participant is detected as being a new active speaker. When application server 16 receives the ASN message from audio server 18, application server 16 parses the ASN message. If the ASN message indicates zero active speakers, application server 16 does not update participant data stored at application server 16 and does not send a notification (NOTIFY) message to server 14. If the ASN message indicates one or more active speakers, application server 16 updates participant data stored at application server 16 with the one or more active speakers indicated in the ASN message and transmits a notification message to server 14 (S118). Server 14 will update participant data 40 based at least in part on the received notification message.

Server 14 receives polling message from device 12 that periodically polls server for updates (S120). In response to the received polling message, server 14 transmits a response message to device 12 in which the response message includes participant data 40 as updated by the notification message received at S124. User interface 20 at device 12 updates displayed information such as a plurality of participants and participant information based at least in part on data in the response message.

Referring back to audio server 18, if audio server 18 detects a new active speaker in the conference, audio server 18 issues another ASN message to application server 16 (S124). The other ASN message, in this example, indicates a second participant, e.g., Participant 3, is an active speaker while the first participant, e.g., Participant 1, is no longer an active speaker. Application server 16 updates participant data stored at application server 16 based at least in part on the information in the ASN message such that, in this example, participant data indicates the first participant is no longer an active speaker and the second participant is an active speaker. In response to receiving the ASN message (S124), application server 16 transmits a notification message with updated participant data to server 14, e.g., updated participant data may indicate the second participant is an active speaker in the conference (S126). Server 14 updates participant data 40 based at least in part on the received notification message. For example, participant data 40 is updated to indicate the first participant is no longer an active speaker and the second participant is an active speaker in the conference. In this manner, if device 12 issues another polling message to server 14, requesting an update, server 14 will transmit updated participant data 44 to device 12 such that information displayed at user interface 20 can be updated (S128-S130). For example, user interface 20 may be update to indicate that Participant 1 is no longer an active speaker and that Participant 3 is a current active speaker as shown in FIG. 2. While messages are shown being transmitted and received in a specific order, the messages are not dependent on each other, e.g., poll/response messages, may be transmitted and received in a different order. Also, although the updating and messaging processes are described using active participants as the selection criteria, it is understood that this is done for ease of understanding and to illustrate the processes. Similar processes can be used for other selection criteria, e.g., seniority level.

The invention advantageously provides each user of device 20 with useful information about participants in the conference in which the provided/displayed information is dynamically configurable by the user via display interface 20, thereby providing users with immediate feedback about additional information about the conference and conference participants. Further, the additional information displayable in section 22 can be used in various clients such as web based, smartphone, tablet, PC and the like that access the conference for audio, video and/or web collaboration, thereby advantageously increasing functionality of the conferencing system as more devices are able to join the multimedia conference.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A computing device for providing a graphical user interface for a conference, the computing device comprising:
a memory, the memory configured to store at least one predefined criterion;
a receiver, the receiver configured to receive participant data, the participant data including:
a list of participants in the conference; and
a subset of participant data associated with each participant in the list of participants in the conference;
a processor, the processor configured to determine if at least one participant in the list of participants in the conference is associated with the subset of participant data that meets the at least one predefined criterion;
a display, the display configured to:
display the list of participants in the graphical user interface; and
display, in the graphical user interface at a place other than the place where the list of participants is displayed in the graphical user interface, the at least one participant associated with the subset of participant data that meets the at least one predefined criterion, the at least one participant being displayed at the same time as the display of the first subset of participant data.

2. The computing device of claim 1, wherein the at least one predefined criterion is met if the subset of participant data associated with a respective participant indicates the respective participant is a current active speaker in the conference.

3. The computing device of claim 2, wherein the at least one predefined criterion is met if the subset of participant data associated with a respective participant indicates the respective participant is a previous current active speaker.

4. The computing device of claim 2, wherein the subset of participant data includes at least one flag associated with a respective participant, the at least one flag indicating whether the respective participant is a current active speaker in the conference.

5. The computing device of claim 1, wherein the display is further configured to display at least one indicator associated with the at least one participant associated with the subset of participant data that meets the at least one predefined criterion.

6. The computing device of claim 5, wherein the at least one indicator indicates the at least one participant is a current active speaker in the conference.

7. The computing device of claim 1, wherein there is a plurality of predefined criteria, the computing device further comprising a user input device, the user input device being configured to allow a user of the computing device to choose from among the plurality of predefined criteria to establish the at least one predefined criterion.

8. The computing device of claim 7, wherein the plurality of predefined criteria includes at least one of a participant being a current active speaker, a participant being a previous current active speaker, a participant having a minimum seniority level and a participant being a current active speaker for a minimum accumulated amount time.

9. The computing device of claim 1, wherein the graphical user interface includes:
a first window configured to display the list of participants in the conference; and
a second window different from the first window, the second window configured to display the at least one participant associated with the subset of participant data that meets the at least one predefined criterion.

10. A system for updating participant data displayed in a graphical user interface at a user device, the participant data being associated with at least one participant in a conference, the system comprising:
a server, the server including:
a memory, the memory configured to store participant data, the participant data including at least a list of participants in a conference and a subset of participant data associated with at least one participant in the list; and
a processor, the processor configured to cause transmission of at least the list of participants in the conference and the subset of participant data for display in respective windows in the graphical user interface.

11. The system of claim 10, wherein the subset of participant data indicates a plurality of active speakers in the conference and at least one previous active speaker in the conference.

12. The system of claim 10, wherein the subset of participant data indicates the seniority level of the at least one participant.

13. The system of claim 10, wherein the server is further includes:
a receiver, the receiver configured to receive a notification message, the notification message indicating at least a portion of the participant data has changed; and
the processor is further configured to:
update at least one of the list of participants in the conference and subset of participant data based at least in part on the received notification message; and
cause transmission of the updated at least one of the list of participants in the conference and subset of participant data for updating participant data displayed in the graphical user interface at the user device.

14. A method for providing a graphical user interface at a computing device for a conference, method comprising:
storing at least one predefined criterion;
receiving participant data, the participant data including:
a list of participants in the conference; and
a subset of participant data associated with each participant in the list;
determining if at least one participant in the list of participants in the conference is associated with the subset of participant data that meets the at least one predefined criterion;
displaying the list of participants in the graphical user interface; and
displaying, in the graphical user interface at a place other than the place where the list of participants in the conference is displayed in the graphical user interface, the at least one participant associated with the subset of participant data that meets the at least one predefined criterion, the at least one participant associated with the subset of participant data that meets the at least one predefined criterion being displayed at the same time as the display of the subset of participant data.

15. The method of claim 14, wherein the at least one predefined criterion is met if the subset of participant data associated with a respective participant indicates the respective participant is at least one of a current active speaker in the conference and a previous current active speaker.

16. The method of claim 14, wherein the subset of participant data includes at least one flag associated with a respective participant, the at least one flag indicating whether the respective participant meets the at least one predefined criterion.

17. The method of claim 14, further comprising displaying at least one indicator associated with the at least one participant that is associated with the subset of participant data that meets the at least one predefined criterion, the at least one indicator indicating the at least one participant associated with the subset of participant data that meets the at least one predefined criterion is a current active speaker in the conference.

18. The method of claim 14, wherein storing at least one predefined criterion includes storing a plurality of predefined criteria; and
the method further comprising allowing a user of the computing device to choose from among the plurality of predefined criteria to establish the at least one predefined criterion.

19. The method of claim 18, wherein the plurality of predefined criteria includes at least one of a participant being a current active speaker, a participant being a previous current active speaker, a participant having a minimum seniority level and a participant being a current active speaker for a minimum accumulated amount time.

20. The method of claim 14, wherein the list of participants in the conference is displayed in a first window in the graphical user interface; and
the at least one participant associated with the subset of participant data that meets the predefined criteria is displayed in a second window of the graphical user interface, the second window being different from the first window.
